(19) United States
(12) Patent Application Publication
(10) Pub. No.: US 2017/0270117 A1
(43) Pub. Date: Sep. 21, 2017

(54) CONVERGING OF DATA MANAGEMENT AND DATA ANALYSIS

(71) Applicant: EMC IP Holding Company LLC, Hopkinton, MA (US)

(72) Inventors: Chao Chen, Shanghai (CN); Xiaoyan Guo, Beijing (CN); Yu Cao, Beijing (CN); Dingmeng Xue, Shanghai (CN); Zed Minhong Zhou, Shanghai (CN)

(21) Appl. No.: 15/463,266

(22) Filed: Mar. 20, 2017

(30) Foreign Application Priority Data
Mar. 18, 2016 (CN) 201610159112.0

(51) Int. Cl. G06F 17/30

(52) U.S. Cl. CPC G06F 17/3012; G06F 17/30076

(57) ABSTRACT

Various embodiments of the present disclosure provide a solution for converging a data management system and a data analysis system at the level of storage. In some embodiments, the present disclosure provides a computer-implemented method. The method includes obtaining, a data management system, a first file in a first format. The method also includes, in response to determining that the first format is different from a predetermined second format supported by a data analysis system, converting the first file into a second file in the second format. The method further includes storing the first and second files to a data storage system. The data storage system is accessible to the data management system and the data analysis system.

### RELATED APPLICATIONS

This application claim priority from Chinese Patent Application Number CN201610159112.0, filed on Mar. 18, 2016 at the State intellectual Property Office, China, titled “Converging of Data Management and Data Analytics” the contents of which is herein incorporated by reference in its entirety.

### FIELD

Embodiments of the present disclosure generally relates to the field of data processing and more particularly, to converging of data management and data analysis at the level of storage.

### BACKGROUND

Enterprises, individual persons, organizations, or government departments would generate contents in various forms, such as electronic documents, digital images, video and audio, and the like. Thus, data management systems may be employed to provide formalized content management and organization so that different users can access to, search for, and edit the contents. Some of the data management systems may be called Enterprise Content Management (ECM) platforms, which provide overall management of contents across the whole platform. The data management system usually stores contents to a storage system associated therewith.

In addition, data analysis systems are applied as data mining took to perform data mining, processing, statistics, and analysis tasks so as to obtain desired information from massive data. Various contents managed by the data management system can usually be used as the mining objects of the data analysis system.

### SUMMARY

Various embodiments of the present disclosure provide a solution for converging a data management system and a data analysis system at the level of storage.

According to a first aspect of the present disclosure, there is provided a computer-implemented method. The method includes obtaining, by a data management system, a first file in a first format. The method also includes, in response to determining that the first format is different from a predetermined second format, converting the first file into a second file in the second format. The second format is supported by a data analysis system. The method further includes storing the first and second files to a data storage system. The data storage system is accessible to the data management system and the data analysis system.

According to a second aspect of the present disclosure, there is provided a device. The device includes at least one processing unit and at least one memory. The at least one memory is coupled to the at least one processing unit and store instructions thereon, the instructions, when executed on the at least one processing unit, cause the device to perform actions including obtaining a first file in a first format and in response to determining that the first format is different from a predetermined second format, convening the first file into a second file in the second format. The second format is supported by a data analysis system. The actions further include storing the first and second files to a data storage system. The data storage system is accessible to the device and the data analysis system.

According to a third aspect of the present disclosure, there is provided a system for data analysis and management. The system includes a data management system including the apparatus according to the above second aspect. The system also includes a data storage system and a data analysis system, the data analysis system being configured to obtain the second file from the data storage system and perform a predefined analysis task based on the second file.

According to a fourth aspect of the present disclosure, there is provided a computer-readable storage medium. The computer-readable storage medium has computer-readable program instructions stored thereon. These computer-readable program instructions are used for performing steps of the method according to the above first aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other objectives, features and advantages of example embodiments disclosed herein will become apparent through the following detailed description with reference to the accompanying drawings. In embodiments of the present disclosure, the same or similar reference symbols refer to the same or similar elements.

FIG. 1 illustrates a block diagram of an architecture for converging a data management system and a data analysis system according to an embodiment of the present disclosure;

FIG. 2 illustrates a flowchart of a process of file adding according to an embodiment of the present disclosure;

FIG. 3 illustrates a flowchart of a process of file deleting according to an embodiment of the present disclosure;

FIG. 4 illustrates a schematic diagram of a correspondence between index files and files to be merged according to an embodiment of the present disclosure; and

FIG. 5 illustrates a schematic block diagram of an example device suitable for implementing embodiments of the present disclosure.

### DETAILED DESCRIPTION

Some embodiments of the present disclosure will be described in more detail below with reference to figures. Although the figures illustrate some embodiments of the present disclosure, it would be appreciated that the present disclosure can be implemented in various manners and should not be limited by the embodiments set forth herein. Rather, these embodiments are provided for the purpose of enabling, a throughout and complete disclosure and completely conveying the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example embodiment” and “an example embodiment” are to be read as “at least one example embodiment.” The term “another embodiment” is to be read as “at least one other embodiment”. The terms “first,” “second,” and the like may refer to different or same objects. Other definitions, explicit and implicit, may be included below.

As used herein, the term “data management system” refers to a system or platform such as an ECM platform which provides content management and organization to enable one or more users to access to, search for and edit such content. As used herein, the term “data analysis system” refers to a system or platform which performs data mining tasks such as data processing, statistics, and analysis to obtain desired information from massive data, examples of which include data analysis platforms such as Spark and Hadoop.

In conventional use, if it is expected to employ a data analysis system to perform data mining on the content managed by a data management system, the data analysis system needs to be assigned with an additional storage system into which the contents stored by the data management system can be imported. This is a process that consumes both time and resources, particularly when the amount of the contents to be imported is massive.

In addition, the data analysis system can usually analyze only a machine-readable text file such as a file in txt format or in log format. However, the data management system stores contents in their original formats as input by the users. Hence, if the contents imported from the management system are not in a format of readable text, the data analysis system has to extract text contents from the imported files. In some cases, the data management system with functionality of full-text search may extract text contents from the managed files for purpose of data search. However, the text contents extracted by the data management system will not be imported into the data analysis system. Therefore, repeated text content extractions are performed at the data analysis system and data management system, which is also a time and resource-consuming process.

To address one or more of the above problems and other potential problems, in accordance with example embodiments of the present disclosure, there is provided a solution for converging a data management system and a data analysis system at the level of storage. The data management system directly stores contents to be managed in a data storage system which is also accessible to the data analysis system.

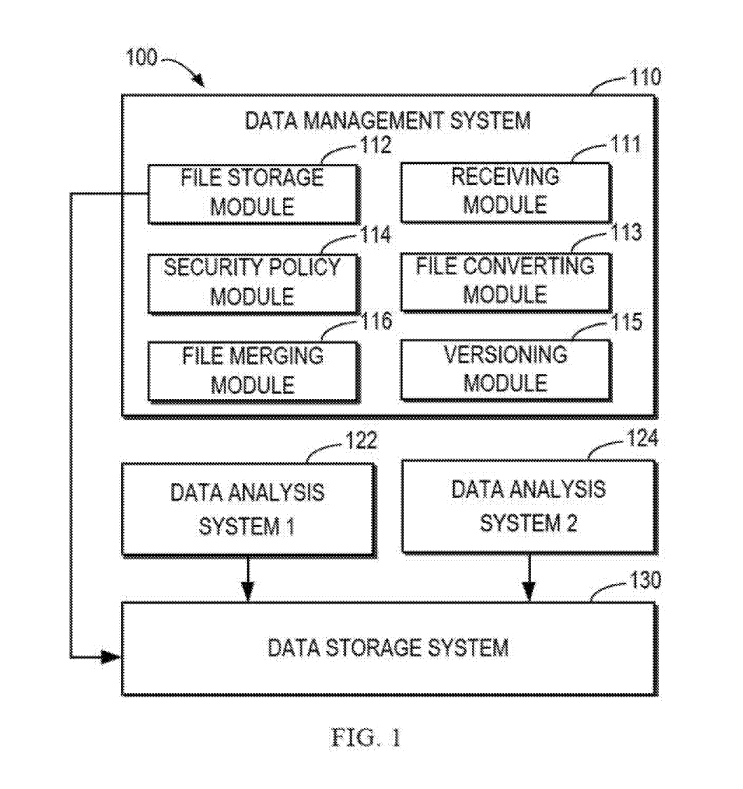

FIG. 1 illustrates a block diagram of an architecture 100 fair converging a data management system and a data analysis system according to an embodiment of the present disclosure. The architecture 100 includes a data management system 110, a data analysis system 1 122, a data analysis system 2 124, and a data storage system 130.

The data management system 110 is configured to receive a file from a user and store the received file into the data storage system 130. Particularly, upon reception of a new file, the data management system 110 may store the file into the data storage system 1311 in its original format. The data management system 110 also converts the file into a readable text format supported by the data analysis system, for example, the data analysis system 1 122 and data analysis system 2 124. The data management system 110 then stores the converted file into the storage system 130. That is to say, in response to a new file, the data management system 110 may store two or more files into the data storage system 130, wherein one of the files is a file in its original format, and others are converted files in formats supported by the data analysis systems 122 and 124.

In embodiments of the present disclosure, the data management system 110 and data analysis systems 122 and 124 are able to access to the data storage system 130. In some embodiments, the data storage system 130 may be a data storage device, a file system, or the like in any form. For example, the data storage system 130 may be a distributed file system such as a Hadoop Distributed File System (FIDES).

The data analysis systems 122 and 124 may access to the data storage system 130 and obtain a file in the supported format. Based on the obtained file, the data analysis systems 122 and 124 may perform a predefined analysis task. The analysis task performed by the data analysis systems is not limited in the embodiments of the present disclosure. Any system for performing data mining may be added into the architecture 100 as a data analysis system.

It can be seen that in the architecture 100, convergence storage is achieved among the data management system 110 and data analysis systems 122, 124. In this way, unlink the case without convergence, the data analysis systems 122 and 124 are not required to export data to be analyzed from a dedicated storage system of the data management system and allocate an additional storage space far storing the data. This can save time and costs of processing resources. In addition, the functionality of text extraction in the data management system 110 can be utilized. The data analysis system 122 or 124 may obtain a directly-readable file text from the data storage system 130 for data mining. As such, it is possible to avoid repeated text content extractions.

In some embodiments, the data analysis systems and/or 124 may report an analysis result after the performing of analysis task to the data management system 110. The data management system 110 may store the analysis result into the data storage system 130 as a received file.

In some embodiments, the data management system 110 includes a receiving module 111, a file storage module 112, a file converting module 113, a security policy module 114, a versioning module 115, and as file merging module 116. These modules a configured to perform corresponding functions. The functions performed by the modules 111-116 included in the data management system 110 will be described in detail below.

It would be appreciated that although FIG. 1 shows that two data analysis systems 122 and 124 can access to the data storage system 130 into which the data management system 110 stores data, less or additional data analysis systems 122 and 124 may also access to the data storage system 130 in other embodiments. It should also be appreciated that a plurality of data management systems may store files to the data storage system 130. In some other embodiments, a plurality of data storage systems can be employed by the data management system 120 to store files.

In some embodiments, the data analysis systems 122 and 124 may support files in the same format. In this case, the data management system 110 may convert the received file into a format supported by both the data analysis systems 122 and 124. In other embodiments, if the data analysis systems 122 and 124 support files in different formats, the data management system 110 may convert the received file into a plurality of renditions and store them to the data storage system 130, and the format of each of the renditions is supported by the data analysis system 122 or 124 respectively.

Detailed depictions will be presented below to discuss specific management of processes such as file adding, file deleting, file update, file visioning, and file merging by the data management system 110 when the data management system 110 and the data analysis systems 122, 124 are converged at the level of storage.

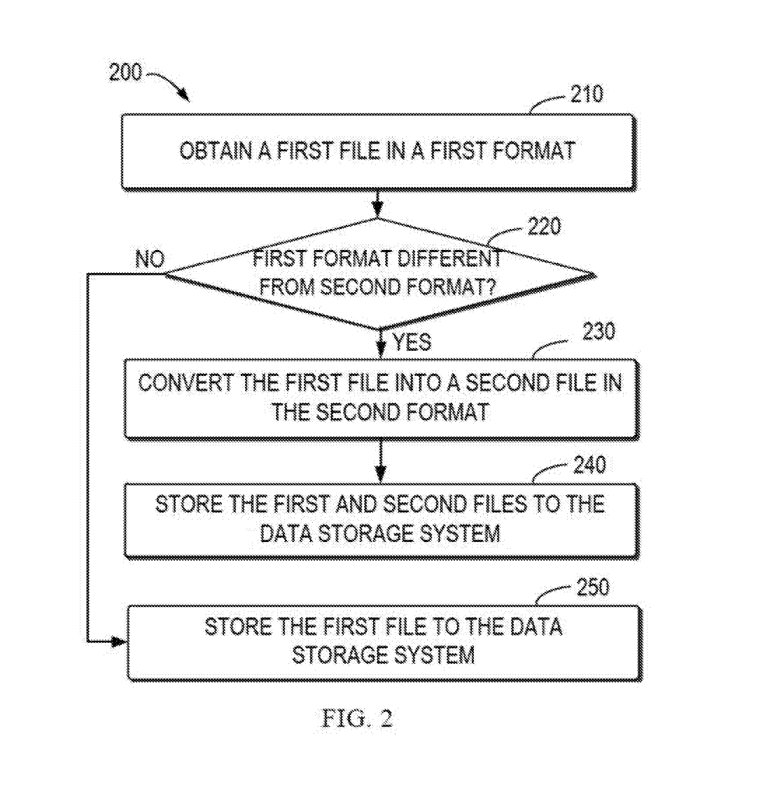

FIG. 2 illustrates a flowchart of a process of file adding 200 according to an embodiment of the present disclosure. The process 200 may be implemented at the data management system 110 which obtains and manages contents. It is to be appreciated that the process 200 may include additional steps and/or omit execution of any shown steps. The scope of the present disclosure is not limited in this regard.

At step 210, the data management system, for example, the receiving module 111 in the data management system 110 obtains a first file in a first format. As used herein, a “file” refers to data/content in any machine-readable format. The user of the data management system may provide any desired data or content to be managed by the data management system. In some embodiments, the first file may be an electronic document, digital image, video, audio, or the like. In some embodiments, the first format may be any machine-readable format, for example, various electronic document formats, digital image formats, video formats and audio formats that are currently used or to be developed in the future.

Then, at step 220 of the process 200, the data management system, for example, the file convening module 113 in the data management system 110 determines whether the first format is different from a second format supported by the data analysis system. In some embodiments, the data management system may be aware of the second format supported by the data analysis system in advance. In some embodiments, the second format may be a text format from which a machine can directly read content, for example, a txt format or log format.

If it is determined at step 220 that the format of the current obtained file is different from the format supported by the data analysis system, the data management system, for example, the file converting module 113 in the data management system 110 converts the first file into the second file in the second format at step 230. As mentioned above, the data management system 110 usually has a capability of extracting text contents from files in various formats.

For example, if the first file is art electronic document in pdf format or excel format in which a machine cannot directly read content, the data management system 110 may extract text contents from the electronic document and generate the second file in the text format based on the extracted contents. As another example, if the first file is an image, the data management system 110 may apply optical character recognition (OCR) processing to recognize contents in the image, including graphs, characters, tables, and the like. In a further example, if the first file is an audio or video file, the data management system 110 may obtain text contents included in the audio or video file using speech recognition techniques.

It would be appreciated that the data management system may extract text contents from the received first file by using any suitable techniques so as to generate the second file. The scope of the present disclosure is not limited in this regard. As used herein, the second file may be a “rendition” of the first file which includes partial or all data/contents of the first file but is in a format different from the first file.

In some embodiments, before converting the first file into the second file, the data management system, for example, the security policy module 114 in the data management system 110 may determine, based on a predefined security policy, whether data included in the first file is accessible to the data analysis system, for example, the data analysis systems 122 and/or 124.

In some embodiments, the predefined security policy may indicate which types of files or contents in the files may not be used by the data analysis system for analysis. For example, some confidential or highly-sensitive files are not expected by a user or enterprise to be exposed to the data analysis system. Thus, the security policy may indicate that a file with confidentiality or sensitivity higher than a predetermined threshold cannot be used by the data analysis system for analysis. In some embodiments, the security policy may be defined by the user and stored in a storage device included by the data management system 110. In some embodiments, the security policy may also be stored in the data storage system 130 and accessed by the security policy module 114 for use. Upon inputting the first file, the user may specify or the data storage system 130 may automatically determine the confidentiality or sensitivity of the first file.

In some embodiments, the format determination of step 220 and the determination of data security policy can he performed simultaneously or in any order. In some embodiments, if it is determined that the data of the first file is accessible to the data analysis system, the file converting module 113 in the data management system 110 may continue to perform step 230 to convert the first file into the second file.

At step 240, the data management system, for example, the file storage module 112 in the data management system 110 stores the first and second files to the data storage system, for example, the data storage system 130. In some embodiments, the file storage module 112 may determine storage paths for the first and second files in the data storage system 130, and store these files according to the corresponding storage paths. In this way, when the data analysis system 122 or 124 desires to analyze the data of the first file, it may access the data storage system 130 to directly obtain the second file that includes the data of the first file for analysis.

In some embodiments, before storing the first and second files to the data storage system 130, the data management system 110 further generates metadata for the first and second files. As used herein, the term “metadata” includes various information in association with a file. For example, the metadata may include but is not limited to: a file name of the file, an author of the file, configurable items such as a company name and address, a key word of the file, a subject matter of the file, version identification of the file, and/or a life cycle of the file, and the like. The metadata may facilitate understanding of the corresponding file.

In some embodiments, the data management system 110 may obtain one or more items in the metadata such as the author, key word, subject matter, and configurable items by processing such as semantic analysis and subject matter extraction. In some embodiments, the data management system 110 may further determine a life cycle of the first file and/or second file in the data storage system 130. The first file and/or second file may be removed from the data storage system 130 upon the life cycle expiring. Alternatively, the metadata of the life cycle may not be included in the metadata but is known by the data storage system 130 or data management system 110 so that the removal of the file can be notified at a specific time.

After the metadata is generated, the file storage module 112 may store the metadata in association with the first and second files to the data storage system 130. In some embodiments, the metadata is stored separately from the first and second files. In some other embodiments, the metadata is combined with any one of the first and second files into a single file for storage. Alternatively, the metadata may further be combined into both the first file and the second file, respectively.

In some embodiments, if it is determined at step 220 that the first format is identical to the second format, the data management system, for example, the file storage module 112 of the data management system 110 may only store the first file to the data storage system 130 at step 250. Alternatively, the data management system 110 may also store the original first file and store the second file as a duplicate of the first file in the data storage system 130. As used herein, the “duplicate” of the first file means that the second file is in the same format as the first file and includes partial or all contents of the first file. The duplicate of the first file may be provided to the data analysis system for performing the analysis task.

In some embodiments, if the security policy module 114 determines that the data of the first file is accessible to the data analysis system, the file storage module 112 may only store the first file into the data storage system 130. In some other embodiments, if the format of the first file is readable by the data analysis system and the first file is not expected to be obtained by the data analysis system for the sake of security, a specific tag may be added to the first file so that the data analysis system may ignore this file when obtaining data for analysis. For example, a corresponding tag may be added to the metadata associated with the first file.

It would be appreciated that when there are a plurality of data analysis systems (for example, data analysis systems 122 and 124) expected to access data from the data storage system 130 and these data analysis systems support different second formats, at step 220 of the process 200, it is determined whether the first format of the received file is identical to any of these second formats. If one or more of the second formats are different from the first format, the data management system 110 may convert at step 230 the first file into the corresponding second files each in different second formats. The data management system 110 may store both the first file and the converted second files into the data storage system 130 for access of the data analysis systems as needed. In addition, in the case that there are a plurality of second formats, other embodiments include that the data management system 140 performs the same operations for each of the second formats as discussed with respect to FIG. 2.

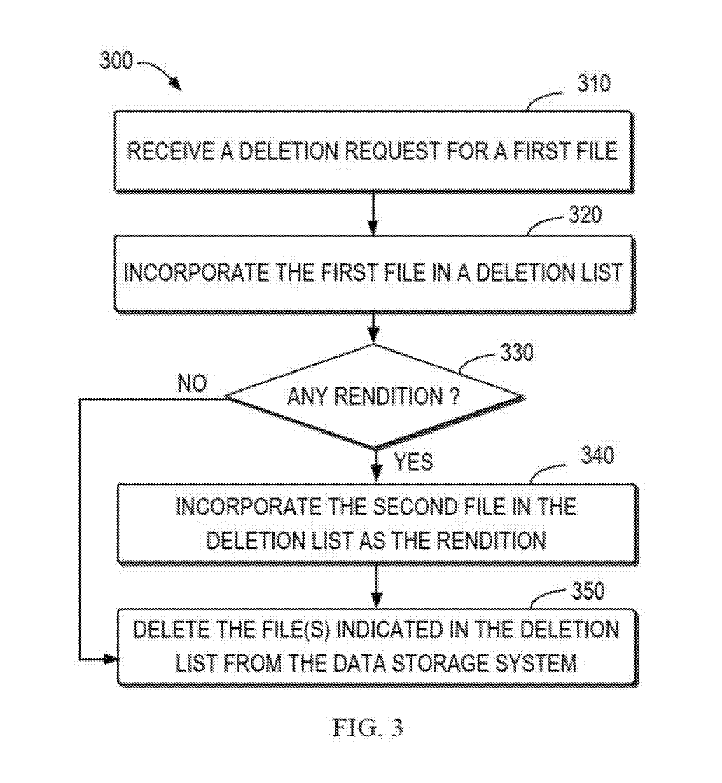

Reference is now made to FIG. 3 which describes a process of file deleting 300 according to an embodiment of the present disclosure. The process 300 may be implemented at the data management system 110. It is appreciated that the process 300 further include additional steps and/or omit execution of any shown steps. The scope of the present disclosure is not limited in this regard.

At step 310, the data management system, for example, the data management system 110 obtains a deletion request for a first file. As described in the process 200 above, the first file is stored in the data storage system 130. In some embodiments, the user of the data management system 110 may actively initiate a request for deleting the first file, and the receiving module 111 may receive the deletion request. Alternatively, or in addition, the data managements system 110 may determine that the life cycle of the first file has already expired and then generate the deletion request for the first file.

The data management system 110 may generate a deletion list having identifiers (for example, file names) of the files to be deleted included therein. At step 320 of the process 300, in response to the deletion request at step 310, the data management system 110 may incorporate the first file into the deletion list.

Due to convergence of the data management system and data analysis system at the level of storage, the data management system may, upon storing the first file, store the rendition(s) of the first file, for example, the second file(s) in different formats into the data storage system. In this case, it is also desirable to delete the second file. In such case, at step 330, the data management system, for example, the data management system 110 determines whether there is a rendition of the first file, that is, whether a second file is stored.

In some embodiments, the data management system 110 may determine whether there is a second file based on whether the first format of the first file is different from the second format supported by the data analysis system. For example, if the first format is different from the second format, the system can determine that the first file is converted to the second file in the file adding process. Alternatively, or in addition, the data management system 110 may determine whether there is the second file based on the security policy of the security policy module 114. If the security policy indicates that the data of the first file is not accessible to the data analysis system, it can be determined that there is no second file.

If it is determined at step 330 that there is a rendition of the first file, the process 300 proceeds to step 340 where the second file is incorporated in the deletion list as the rendition. For example, an identifier (for example, a file name) of the second file may be included in that list. Then, at step 350, the first file and second file indicated in the deletion list are deleted from the data storage system 130. If it is determined at step 330 that there is no rendition of the first file, the first file indicated in the deletion list may be deleted from the data storage system 130 at step 150. In deletion of a file, the data management system 110 may determine a storage path of the file and delete the corresponding file from the data storage system according to the storage path.

It would be appreciated that if there are a plurality of renditions of the first file, for example, second files in a plurality of formats, these files may all be added to the deletion list so as to implement the deletion operation. In the case of presence of metadata in association with the first file and/or second file, the corresponding metadata may also be deleted. In some embodiments, when the first format is identical to the second format, the data management system 110 may further determine whether there is a duplicate of the first file, and put the duplicate in the deletion list if there is.

It would also be appreciated that in some other embodiments of file deletion, the data management system 110 may not generate the deletion list. The data management system 110 may directly delete the first file from the data storage system 130 at step 330 of the process 300, and directly delete the rendition or duplicate from the data storage system 130 at step 340 when it is determined that there is the rendition or duplicate of the first file. In these embodiments, step 350 of the process 300 is omitted.

The process of adding a file into the data storage system by the data management system has been described above with reference to FIG. 2; and the process of deleting a file from the data storage system by the data management system has been described above with reference to FIG. 3. In some embodiments, the user of the data management system, for example, the data management system 110 may desire to update a file that is previously input into the data storage system, such as the first file. In this case, the data management system 110 may delete the first file that is previously stored in the data storage system and add the updated first file into the data storage system. That is to say, the process of file update may involve two processes: the process of file adding and the process of file deleting.

The process of deleting the original first file may refer to the process 300 described above with reference to FIG. 3. Specifically, if the user updates the first file, the data management system 110 may generate a deletion request for the first file and thus initiate the process 300 to delete the first file and probably the second file. Further, the addition of the updated first file may refer to the process 200 described above with reference to FIG. 2. Specifically, the updated first file may be added into the data storage system 130 as a new file Received. If the first format (the update of the first file usually will not change its file format) is different from the second format, the data management system 110 may convert the updated first file into a third file in the second format and then store the updated first file and the convened third file into the data storage system 130. It would be appreciated that if the first format is identical to the second format, the data management system 110 may only store the updated first file into the data storage system 130 or may store the updated first file and its duplicate into the data storage system 130.

It would be appreciated that in the case of file update, there is no limiting to the order of the process of deleting the old file and the process of adding the updated file. For example, the old file may be deleted first and then the updated file is added. Alternatively, the updated file may be added first and then the old file is deleted. In some other embodiments, it is possible to perform both the deletion of the old file and the addition of the updated file in parallel.

In some cases, the data management system, for example, the user of the data management system 110 may for example use the visioning module 115 to create a new version of the first file (which is referred to as a fourth file). The fourth file is usually in the same first format as the first file. Those skilled in the an will understand that versioning of a file different from an update of the file. The versioning of the file creates a new file, whereas the update of the file involves update of content in the original file and may not produce a new file.

In the case of file versioning, the data management system 110 may, after obtaining the fourth file, add the fourth file into the data storage system 130 with the process of file adding described above with reference to FIG. 2. Specifically, if the first format is different from the second format supported by the data analysis system, the fourth file may be converted into a fifth file in the second format. Then, the fourth and fifth files are stored into the data storage system 130. If the first format is identical to the second format, only the fourth file may be stored, or both the fourth file and a duplicate of the fourth file may be stored.

In some embodiments, in the case of creating different versions for a first file, the metadata associated with the first, file may include a version identifier of the file. After a new version of the first file is created, the version identifier in the metadata associated with the first file may be updated. The version identifier may indicate a version serial number of the first file. In some embodiments, the metadata associated with the first file may be associated with the fourth file, and the metadata may identify the fourth file as the newest version among various versions. Alternatively, new metadata may further be generated for the fourth file.

Generally, it is more beneficial for the data storage system, for example, a distributed file system to store large-sized files. In some cases, the respective files managed by the data management system may be small in size. Thus, a file merging technique may be employed during the storage to merge a plurality of files into one file and store this file into the data storage system. Specifically, the file merging module 116 of the data management system, for example, of the data management system 110, may perform a process of file merging for files to be stored in the data storage system 130, including the files to be stored by the user and renditions or duplicates of the files. The number of files to be merged each time is not limited.

In some embodiments, the data management system 110 may first store all the files to be stored into the data storage system 130. After a period of time (for example, based on the set execution frequency), the file merging module 116 instructs the merging of the stored files. In some other embodiments, the data management system 110 may merge the files and then store the merged file into the data storage system 130.

In some embodiments, the files may be merged based, on a predefined rule. The predefined rule may include but is not limited to: selection of files to be merged, an execution frequency of the process of file merging, the execution time for the process of file merging, a format of the merged file, storage location, file size, and the like. In some embodiments, the files to be merged may be selected based on the latest modification time, the degree of activity (for example, how frequently the file is searched, edited, and looked up by the user) and/or a life cycle of each file. For example, it is possible to merge a plurality of files in the data storage system 130 that are relatively “old” since the latest modification times, with low degree of activity degree, and/or have short remaining life cycles because these files are less probably re-used by the user. Alternatively, or in addition, the user may be allowed to select one or more files to be merged. In some embodiments, an execution frequency and/or execution time of the process of file merging may be set. For example, it is possible to set to automatically perform the file merging at an idle time period of the data management system, and/or to perform the file merging once a month or a week. In some embodiments, if the merged file includes files to be accessed by the data analysis system, the merged file may be stored in a format readable by both the data analysis system and the data management system so that the data analysis system and the data management system read can read files therefrom.

In some embodiments, to determine respective files from the merged file, an associated index file may be created. for each of the files to be merged. The index file may be used to map the small file to be merged into the large merged file. In some embodiments, the index file may include an identifier of the merged file, an identifier of the associated file, and an offset of the associated file in the merged file.

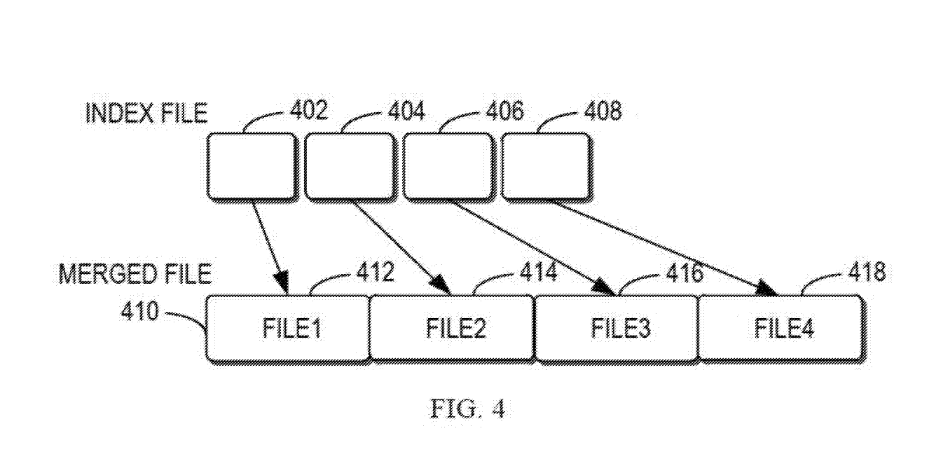

FIG. 4 illustrates correspondence between index files and the files to be merged. Files 1-4 412-418 are to be merged into a file 410. An index file 402 is created to specify an identifier (for example, a file name) of the merged file, an identifier of the file 412, and an offset (for example, 0) of the file 412 in the file 410 after the merging. Index files 404-408 may be generated similarly, where the index file 404 is associated with the file 414, the index file 406 is associated with the file 416, and the index file 408 is associated with the file 418. These index files can be used to identify corresponding small files from the file 410 after the merging. It would be appreciated that the number of files as shown in FIG. 4 is an example, and more than four or less than four files may be merged into one file.

In some embodiments, a plurality of index files it different merged files may be merged into one file. Alternatively, or in addition, the plurality of index files may be stored in association with a merged file, for example, may be merged with the merged file. In other embodiments, the plurality of index files may be stored separately.

In some embodiments, for the merged file, if one or more files included therein are to be deleted during the process of file deleting, for example, the process of file deleting 300, these files may be identified as invalid during, the process of file deleting. Then, the file merging module 116 may remove the files that are identified as invalid from the merged file, and may delete the corresponding index files. In some embodiments, new files may be added into the merged file so that the merged file meets a required size.

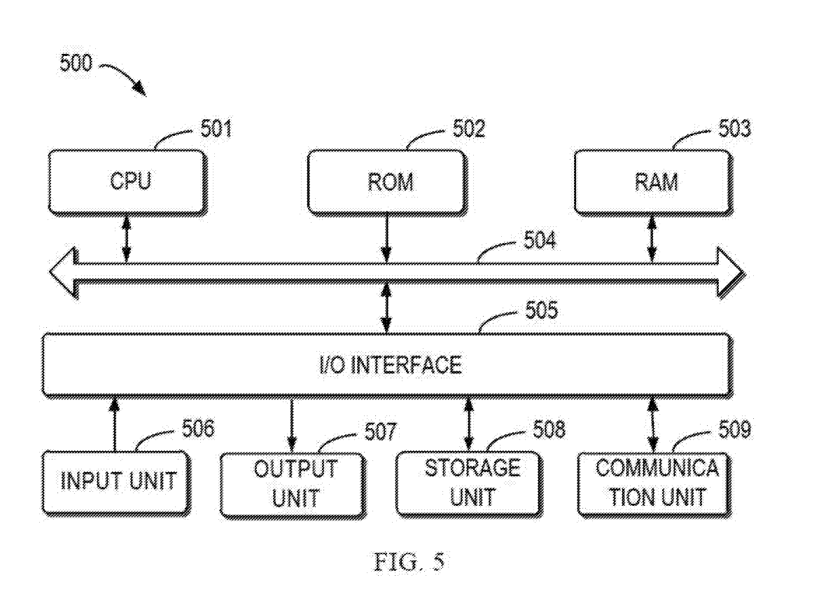

FIG. 5 illustrates a schematic block diagram of an example device 500 suitable for implementing embodiments of the present disclosure. As shown, the device 500 includes a central processing unit (CPU) 501 which is capable of performing various suitable actions and processes in accordance with computer, program instructions stored in a read only memory (ROM) 502 or loaded from a storage unit 508 to a random access memory (RAM) 503. In the RAM 503, various programs and data required for operation of the device 500 may also be stored. The CPU 501, ROM 502, and RAM 503 are connected to one another via a bus 504. An input/output (I/O) interface 505 is also connected to the bus 504.

Various components in the device 500 are connected to the I/O interface 505, including an input unit 506 such as a keyboard, a mouse, and the like; an output, unit 507 such as various kinds of display, loudspeakers, and the like; the storage unit 508 such as a magnetic disk, an optical disk, and the like; and a communication unit 509 such as a network card, a modem, a radio communication transceiver, and the like. The communication unit 509 enables the device 500 to communicate information/data with other devices via a computer network such as Internet and/or various telecommunication networks.

The processes and operations, such as the process 200 and/or process 300 described above, may be implemented with the processing unit 501. For example, in some embodiments, the process 200 and/or process 300 may be implemented as a computer software program, which is tangibly included in a machine-readable medium such as the storage unit 508. In some embodiments, partial or all of the computer program may be loaded and/or installed on the device 500 via the ROM 502 and/or communication unit 509. When the computer program is loaded to the RAM503 and executed by the CPU501, one or more steps of the above process 200 and/or process 300 may be performed.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can maintain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination thereof. A list of specific but not exclusive examples of the computer readable storage medium includes a portable computer disk, a hard disk, a random access memory (RAM), a read-only memory (ROM), an erasable programmable read-only memory (EPROM Or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination thereof. A computer readable storage medium, as used herein, is not to be construed as transitory signals such as radio waves or other freely propagating electromagnetic waves, electromagnetic waves propagating through as waveguide or other transmission media (for example, light pulses passing through a fiber-optic cable), or electrical signals transmitted through a wire line.

Computer readable program instructions described herein can be downloaded to respective computing/processing devices from a computer readable storage medium or to an external computer or external storage device via a network, for example, the Internet, a local area network, a wide area network, and/or a wireless network. The network may include copper transmission cables, optical transmission fibers, wireless transmission, routers, firewalls, switches, gateway computers, and/or edge servers. A network adapter card or network interface in each computing/processing device receives computer readable program instructions m the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages such as the “C” programming language or similar programming languages. The computer readable program instructions may execute entirely on the user computer, partly on the user computer, as a stand-alone software package, partly on the user computer and partly on a remote computer or entirely on the remote computer or server, in the latter scenario, the remote computer may be connected to the user computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which executed by the processor of the computer or other programmable data processing apparatus, create means for implementing the functions/actions specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored thereon comprises an article of manufacture including instructions which implement aspects of the functions/actions specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions, which executed on the computer, other programmable apparatus, or other device, implement the functions/actions specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The description of various embodiments of the present disclosure has been presented for purposes of illustration but not exhaustive, and is not intended to limit the embodiments disclosed. Various modifications and variations will be apparent to those ordinary skilled in the art without departing from the scope and spirit of the described embodiments. The terminology used herein is chosen to best explain the principles of the embodiments, the practical application, or technical improvement over technologies in the art, or to enable other ordinary skilled in the art to understand the embodiments disclosed herein.

1. A computer-implemented method, comprising:
obtaining, by a data management system, a first file in a first format;
in response to determining that the first format is different from a predetermined second format supported by a data analysis system, converting thee first file into a second file in the second format; and
storing the first and second files to a data storage system accessible to the data management system and the data analysis system.

2. The method according to claim 1, wherein converting the first file into the second file in the second format comprises:
determining, based on a predefined security policy, whether data included in the first file is accessible to the data analysis system; and
in response to determining that the data is accessible to the data analysis system, converting the first file into the second file.

3. The method according to claim 1, further comprising:
generating metadata for the first and second files; and
storing to the data storage system the metadata in association with the first and second files.

4. The method according to claim 1, further comprising:
in response to determining that the first format is identical to the second format, storing the first file to the data storage system.

5. The method according to claim 1, further comprising:
in response to a request for deleting the first file stored in the data storage system, deleting the first file from the data storage system; and
in response to determining that the first file has been converted into the second file, deleting the second file from the data storage system.

6. The method according to claim 5, further comprising:
in response to an update of the first file stored in the data storage system, generating the request for deleting the stored first file.

7. The method according to claim 6, further comprising:
in response to determining that the first format is different from the predetermined second format, converting the updated first file into a third file in the second format; and
storing the updated first file and the third file to the data storage system.

8. The method according to claim 3, wherein the metadata includes a version identifier for data in the first file, the method further comprising:
in response to obtaining a fourth file in the first format as a different version of the first file, updating the version identifier.

9. The method according to claim 1. further comprising:
in response to obtaining a fourth file in the first format as a different version of the first file, converting the fourth file into a fifth file in the second format; and
storing the fourth and fifth files to the data storage system.

10. The method according to any of claims 1, further comprising:
merging at least one of the first and second files with at least one further file to obtain a merged file; and
storing the merged file into the data storage system.

11. The method according to claim 10, further comprising:
generating an associated index file for a respective file in the merged file, the index file including an identifier of the merged file, an identifier of the respective file, and an offset of the respective file in the merged file; and
storing the index file into the data storage system.

12. A device, comprising:
at least one processing unit; and
at least one memory coupled to the at least one processing unit and storing instructions thereon, the instructions, when executed by the at least one processing, unit, cause the device to perform actions including:
obtaining a first file in a first format;
in response to determining that the first format is different from a predetermined second format supported by a data analysis system, converting the first file into a second file in the second format; and
storing the first and second files to a data storage system accessible to the device and the data analysis system.

13. The device according to claim 12, wherein converting the first file into the second file in the second format comprises:
determining, based on a predefined security policy, whether data included in the first file is accessible to the data analysis system; and
in response to determining that the data is accessible to the data analysis system, converting the first file into the second file.

14. The device according to claim 12, wherein the actions further include:
generating metadata for the first and second files; and
storing to the data storage system the metadata in association with the first and second files.

15. The device according to claim 12, wherein the actions further include:
in response to determining that the first format is identical to the second format, storing the first file to the data storage system.

16. The device according to claim 12, wherein the actions further include:
in response to a request for deleting the first file stored in the data storage system, deleting the first file from the data storage system; and
in response to determining that the first file has been converted into the second file, deleting the second file from the data storage system.

17. The device according to claim 16, wherein the actions further include:
in response to an update of the first file stored in the data storage system, generating the request for deleting the stored first file.

18. The device according to claim 16, wherein the actions further include:
in response to determining that the first format is different from the predetermined second format, converting the updated first file into a third file in the second format; and
storing the updated first file and the third file to the data storage system.

19. The device according to claim 14, wherein the metadata includes a version identifier for data in the first file, the actions further including:
in response to obtaining a fourth file in the first format as a different version of the first file, updating the version identifier.

20. The device according to claim 12, wherein the actions further include:
in response to obtaining a fourth file in the first format as a different version of the first file, converting the fourth file into a fifth file in the second format; and
storing the fourth and fifth files to the data storage system.

21-24. (canceled)
